(19) United States
(12) Patent Application Publication
(10) Pub. No.: US 2007/0267771 A1
(43) Pub. Date: Nov. 22, 2007

(54) METHOD AND SYSTEM FOR MAKING MOLDED FOAM PARTS

(75) Inventor: Robert D. EARNEST, Lake Orion, MI (US)

Correspondence Address: CONLEY ROSE, P.C., 5601 GRANITE PARKWAY, SUITE 750, PLANO, TX, 75024, US

(73) Assignee: L&P Property Management Company, South Gate, CA (US)

(21) Appl. No.: 11/833,110

(22) Filed: Aug. 2, 2007

Related U.S. Application Data
(60) Provisional application No. 60/821,448, filed on Aug. 4, 2006.

(51) Int. Cl. B29C 44/12

(52) U.S. Cl. 264/46.4; 428/411.1; 425/117

(57) ABSTRACT

A system and method for making molded foam parts having a reinforcing sheet integrally molded onto a surface of the finished part. One or more magnetic elements, e.g. magnets, are positioned on an inner surface of a mold. Magnetic particles, e.g. iron, are bonded to or embedded in a surface of a reinforcing sheet. The magnetic particles may be mixed with a binder and sprayed, screen printed or otherwise applied to a surface of the sheet. The sheet is positioned in the mold adjacent the magnetic elements and held in place by magnetic attraction. Foam forming chemicals may then be reacted in the mold to form a foam part with the sheet bonded to the foam part in a desired location.

### CROSS-REFERENCE TO RELATED APPLICATIONS

The present application claims priority from U.S. Provisional patent application Ser. No. 60/821,448, titled Method and System for Making Molded Foam Parts, filed on Aug. 4, 2006 which is hereby incorporated by reference for all purposes.

### STATEMENT REGARDING FEDERALLY SPONSORED RESEARCH OR DEVELOPMENT

Not applicable.

### REFERENCE TO A MICROFICHE APPENDIX

Not applicable.

### FIELD OF THE INVENTION

The present invention relates to molded foam parts having a sheet of material molded on a surface of the part and more particularly to a system and method for using magnetic attraction to hold a sheet of material in position in a mold while the foam is poured in the mold.

### BACKGROUND OF THE INVENTION

Many shaped foam parts are produced by mixing foam forming chemicals and reacting them in a mold of the desired shape. It is often desirable to attach a reinforcing sheet, e.g. a woven or nonwoven fabric, to at least one surface of the foam part for various purposes, e.g. to provide added wear resistance, strength or rigidity to the surface. Various systems and methods are known for adhesively bonding reinforcing sheets to previously formed foam parts. Use of an adhesive can be avoided if a reinforcing sheet is placed in a mold before the foam is reacted, since as the foam is formed it may naturally bond to the sheet.

When the reinforcing sheet is placed in the mold, it is important that the sheet remain in position in the mold adjacent the proper mold surface and not move, fold, wrinkle, etc. as the foam is reacted in the mold. In many molding systems, the mold is operated in a vertical position, i.e. the mating mold surfaces are essentially vertical, in order to facilitate removing finished parts from the mold. In such molds, a reinforcing sheet will normally need to be positioned against a vertical mold surface. If molds are operated in a horizontal position, it may be desirable to attach the reinforcing sheet to the top surface of the finished part and the reinforcing sheet must be positioned adjacent an upper surface of the mold.

To prevent the reinforcing sheet from falling to the bottom of the mold or moving from the desired position, a system using discrete magnetic materials attached to the reinforcing sheet and the inner mold surface has been used. For example, metal dots or disks having contact adhesive have been pressed onto one side of a reinforcing sheet in selected locations. A corresponding pattern of magnets have been positioned on the inner surface of a mold. The reinforcing sheet may then be positioned against the mold surface and held in place by magnetic attraction between the metallic dots and the magnets. Such a system generally requires manual positioning of the metal dots on the fabric. The attached dots often are dislodged in handling so that a given sheet may not be useful in the molding process, or worse yet, may move after a mold is closed and be in the wrong position when the foam is poured, resulting in a defective foam part.

### SUMMARY OF THE INVENTION

In this disclosure, a reinforcing sheet for use in a foamed part mold is provided with a coating of magnetic material particles that are attracted to a mating magnetic material in or on the inner surface of a foam mold.

In one embodiment, the magnetic material particles are mixed with a binder and applied to a surface of a reinforcing sheet.

In one embodiment, an adhesive material is applied to a reinforcing sheet and the magnetic particles are distributed over the adhesive.

In one embodiment, the magnetic particles are applied to the reinforcing sheet in a pattern to provide at least one dimensional registration of the sheet with a mold surface.

### BRIEF DESCRIPTION OF THE DRAWINGS

FIG. 1 is a cross sectional view of a foam cushion mold useful in an embodiment.

FIG. 2 is a cross sectional view of a cushion made in the mold of FIG. 1

FIG. 3 is a plan view of a reinforcing sheet useful in an embodiment.

FIG. 4 is a plan view of a reinforcing sheet useful in another embodiment.

### DETAILED DESCRIPTION OF THE PREFERRED EMBODIMENTS

Typical parts that may be made in various embodiments include automobile seat and back cushions, pillows, furniture cushions, shoe insoles, mattresses, etc. Embodiments will be described with reference to seat cushions, with the understanding that the same systems and methods are applicable to other foam parts. Seat cushions, especially automobile seat cushions, are exposed to many forces that can distort or tear the foam and its coverings. In automobile cushions, the bottom side of the cushion may be exposed to and come into contact with various wires and cables, e.g. those related to electric adjustment mechanisms, seat belt sensors, seat heaters, etc. As the seat is moved, such contact may cut or tear the foam. In any case, the seat cushion is supported by a seat frame, usually metal, which could cut or tear the cushion. It is desirable to provide the bottom of the foam cushion with a reinforced surface to resist damage from contact with the frame and such sensors, wires and cables. In the disclosed embodiment, a reinforcing sheet is attached to a surface of the molded foam part by being molded in place as the part is formed.

In this disclosure, the term magnet refers to a magnetic material having an essentially permanent magnetic field, often referred to as a permanent magnet. A magnetic substance is a magnetic material that is attracted by or to a magnet, but does not possess a permanent magnetic field. The term magnetic material therefore refers to both a magnet and a magnetic substance.

In FIG. 1, a seat cushion mold 10 is illustrated having two mating halves 12 and 14 made primarily of a nonmagnetic material such as aluminum. The mold halves 12, 14 meet at parting line 16 when the mold is closed as illustrated. A port or flow path 18 is provided for inserting foam forming chemicals into the mold after it is closed as indicated by the arrow 20. Alternatively, the foam forming chemicals may be placed in the mold when it is open, so long as the mold is quickly closed so that the reacting materials are retained within the mold. The foam forming chemicals used depend on the type of foam desired. For example, if urethane foam is desired, the chemicals may include a polyol and an isocyanate.

A reinforcing sheet 22 is shown positioned against an inner surface 24 of mold half 14. In this embodiment, the mold 10 is positioned vertically, that is with the parting line 16 and mold surface 24 substantially vertical. A magnetic attraction system is used to hold the reinforcing sheet 22 in position adjacent the surface 24. A plurality of magnetic material elements, e.g. magnets, 26 are embedded into the surface 24 of the mold 10 half 14. As described in more detail below, magnetic material particles, e.g. particles of a magnetic substance, are coated on, or embedded into, the sheet 22 in locations appropriate for holding the reinforcing sheet 22 in position against the surface 24, e.g. in a pattern matching the positions of magnets 26.

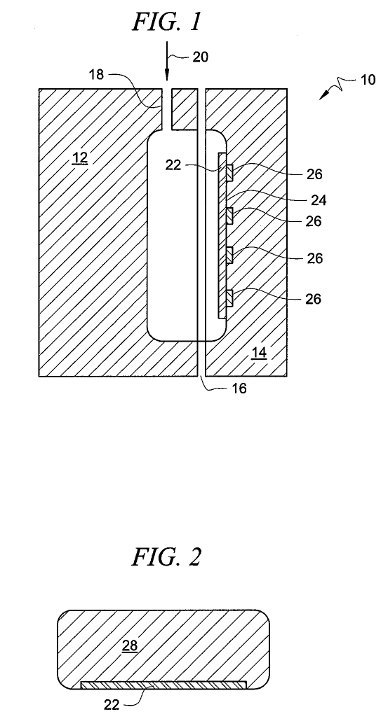

FIG. 2 illustrates a seat cushion 28 that may be made in the mold 10. In this embodiment, the cushion 28 is a polyurethane foam cushion having a reinforcing sheet 22 on its bottom surface. The reinforcing sheet 22 is attached to the foam because the foam was poured or reacted in place in the mold 10 with the reinforcing sheet 22 positioned in the mold 10 as shown in FIG. 1.

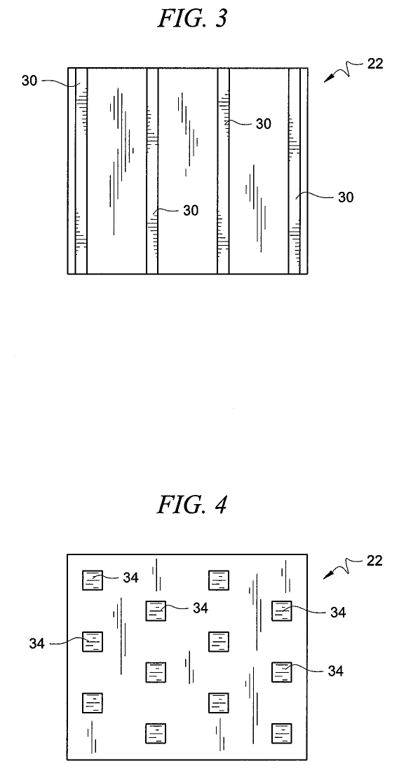

FIG. 3 is a plan view of one side of a typical reinforcing sheet 22. The sheet 22 may be cut from a roll of woven or nonwoven fabric or scrim selected for the desired mechanical properties. In FIG. 3, four strips or stripes 30 comprising magnetic materials have been applied to the surface of sheet 22. In this embodiment, the strips comprise particles of a magnetic substance, e.g. iron particles, mixed with a binder and applied to a surface of the reinforcing sheet 22. In this embodiment, the magnetic material elements 26 of FIG. 1 are magnets embedded into the surface 24 and arranged in rows spaced apart by the same distance as the strips 30. If desired, the magnets 26 may be formed as continuous strips corresponding to the strips 30.

FIG. 4 is a plan view of an alternative form of reinforcing sheet 22. In this embodiment, a plurality of small areas 34, which may be square as illustrated, but may be round or any other desired shape, comprising magnetic materials have been formed on the surface of, or embedded into, sheet 22. The areas 34 may be generally arranged in vertical rows that are spaced apart horizontally like strips 30 of FIG. 3. The areas 34 in each row may be spaced apart vertically in different patterns as illustrated. In this embodiment, the magnets 26 need to be spaced apart in the same pattern as shown in FIG. 4. By proper selection of the configuration of the areas 34 and magnets 26, the proper registration and orientation of the reinforcing sheet 22 on the surface 24 may be assured.

As another alternative to those shown in FIGS. 3 and 4, an entire surface of the reinforcing sheet 22 may be coated with magnetic material particles. If an entire surface of sheet 22 is so coated, then it can be applied to the surface 24 in a number of different positions and orientations since the entire sheet 22 would be attracted to the magnets 26. If the FIG. 3 embodiment is used, the stripes 30 help register the reinforcing sheet 22 with a desired location on the surface 24 at least in one direction, in this case the horizontal direction. If the FIG. 4 embodiment is used, the areas 34 may help register the reinforcing sheet 22 on the surface 24 horizontally and vertically, and with proper positioning of areas 34, even rotationally.

In the embodiments discussed above, the magnetic material elements 26 are magnets and the particles applied the reinforcing sheet 22 are magnetic substances. If desired, the elements 26 may be formed of a magnetic substance such as iron and the magnetic material particles applied to sheet 22 may be magnet particles. If desired, both the elements 26 and the particles may be magnets. In any case, the materials are selected to provide magnetic attraction between the elements 26 and the particles coated on or embedded into the reinforcing sheet 22.

Various methods are suitable for coating magnetic material particles onto the reinforcing sheet 22. In one embodiment, a spray contact adhesive may be sprayed onto a surface of the sheet 22. Particles of a magnetic substance, e.g. iron powder, may then be sprinkled or dusted onto the sprayed on contact adhesive. To form the patterns shown in FIGS. 3 and 4, a stencil or mask may be placed over the sheet 22 before the adhesive is sprayed. Alternatively, a hot melt glue gun may be used to apply adhesive in the areas 34 and a magnetic material may be dusted onto the adhesive while it is still tacky. On one embodiment a polyamide or polyester thermoplastic heat activated adhesive resin binder may be screen printed onto the sheet material and ferromagnetic particles may be dusted onto the freshly printed binder and thereby bonded to the sheet at the desired locations.

Alternatively, the magnetic material particles may be mixed with a binder, e.g. liquid latex, and the liquid mixture may be applied by any known means of coating a liquid material onto a surface. For example, the mixture may be applied by spraying, by a roll process, or by a screening process. A screen process may be desirable for applying the mixture in a pattern, e.g. the pattern of FIG. 3 or of FIG. 4. Screen printable coatings may include a polyamide or polyester thermoplastic heat activated adhesive resin binder doped with micron sized ferromagnetic particles. In an embodiment, the binder is a urethane binder mixed with magnetic particles to form a paste suitable for screen printing. The binder may comprise fifteen to sixty-five percent of the paste. In an embodiment, other materials such as print enhancers and chelating agents or other anti-corrosion materials comprise about three percent of a screen printable paste.

In one embodiment, magnetic particles are applied to a surface of reinforcing sheet 22 that is to be positioned in contact with the mold surface 24. In this position the magnetic substance would be as close as possible to the elements 26 and may provide the maximum magnetic attraction. However, the reinforcing sheet 22 is typically thin enough that the magnetic material may be applied to the side of sheet 22 that will be adjacent the poured foam and opposite the surface 24 and should achieve sufficient magnetic attraction to hold the reinforcing sheet 22 in place. In some cases, the reinforcing sheet 22 may be applied to a surface of a foam part that will be visible in use and it may be desired that the stripes 30 or areas 34 not be visible. By coating the surface that ends up between the sheet 22 and the cushion 28, the magnetic coating will be hidden from view.

In this embodiment, the mold 10 is positioned vertically. In other applications, it is desirable to position the mold 10 horizontally. In some cases, it is desirable to mold a reinforcing sheet 22 on the top of the part or on both top and bottom. In all such cases, the system of the present invention allows a sheet to be positioned properly in a mold while the foam part is formed, even when the sheet 22 is on top of the finished part.

The reinforcing sheet 22 may be made of various materials depending on the particular application. The reinforcing sheet 22 may comprise natural or man made, e.g. synthetic, fabrics, textiles, scrims, blends or films. The reinforcing sheet 22 may be point bonded or flat bonded spunbond or other non-woven fabric, or woven fabric or other textile type. The sheet 22 may comprise cotton, rayon, polyester, nylon, polypropylene, polyamide or polyimide fibers. In addition to cotton and rayon, the sheet 22 may be made of other cellulosic fibers such as wood fibers, and thus the sheet may be a sheet of paper or cardboard.

The sheet 22 is referred to herein as a reinforcing sheet, since it has typically been used to increase the resistance of a molded foam part to wear, deformation or damage by contact with other items during its intended use. The sheet 22 may be made of a decorative material or upholstery type of fabric intended to be seen and/or contacted by users during its intended use, for example the top surface of a seat cushion.

Suitable magnetic particles include micron sized ferromagnetic particles, such as iron, ferric oxide and magnetic stainless steel. In an embodiment, the magnetic particles are iron particles comprising seventy percent to 99.9 percent iron. Suitable iron particles may be from 40 to 200 micron in size. In one embodiment the iron particles may be a mixture of particles from 40 to 90 microns while in other embodiments, the mixture may range from 80 to 160 microns. When iron particles are used, it may be desirable to include a chelating agent or other corrosion inhibitor to limit formation of rust.

In an embodiment, the reinforcing sheet 22 is cut from a continuous roll of the material after the desired pattern of magnetic material as shown in FIGS. 3 and 4 has been applied to the sheet material. A tubular screen-printing system may be used to apply the magnetic material to the roll of sheet material is an essentially continuous process. The sheet material may then be slit and die cut to desired shapes and sizes using automated equipment. The reinforcing sheets 22 may then be delivered to the foam molding system ready for positioning in the mold 10 by means of the preprinted magnetic material.

A foam part, e.g. seat cushion 28, may be made using the mold 10 and a reinforcing sheet 22 prepared as discussed above. The mold 10 is opened so that the inner surfaces, including surface 24 may be accessed. It is usually desirable to spray all inner surfaces or faces of mold 10 with a mold release to prevent the foam from bonding to the mold 10 itself. A prepared reinforcing sheet 22 is then positioned against the surface 24 and held in place by magnetic attraction between the magnets 26 and the magnetic particles on reinforcing sheet 22. The mold may then be closed and a suitable chemical mixture may be injected through port 18 into the closed mold 10. Alternatively, the chemical mixture may be placed in one or both halves 12 and 14 of the mold and then the mold 10 may be closed. In some cases, the mold 10 may be heated to a temperature selected to facilitate reaction of the chemicals and proper curing into a desired foam structure. The chemical mixture then reacts and expands to form foam filling the mold 10 and adhering to the sheet 22. After the foam has cured, the mold 10 is opened and a finished foam part including the reinforcing sheet 22, e.g. cushion 28, is removed from the mold 10. Mold flashings may then be trimmed from the cushion 28.

While the invention has been disclosed with reference to particular embodiments and materials, it is apparent that various modifications and additions may be made within the scope of the present invention as covered by the following claims.

What we claim as our invention is:

1. A method for making a foam part including a sheet of material bonded to a surface of the part, comprising:
coating at least one portion of at least one surface of a sheet with particles of a first magnetic material,
coupling at least one second magnetic material to an inner surface of a mold,
positioning the sheet adjacent the inner surface of the mold with the at least one portion of the sheet proximate the at least one second magnetic material, whereby magnetic attraction between the first magnetic material and the second magnetic material resist movement of the sheet relative to the mold, and
reacting foam forming chemicals in the mold.

2. The method of claim 1, further comprising:
coating the at least a portion of the at least one surface of a sheet with an adhesive and distributing the particles of the first magnetic material on the adhesive.

3. The method of claim 1, further comprising:
mixing the particles of the first magnetic material with a binder and coating the at least one portion of the at least one surface of the sheet with the mixture of binder and particles of magnetic material.

4. The method of claim 3, further comprising:
screen printing the mixture of binder and particles of the first magnetic material onto the sheet.

5. The method of claim 3, further comprising:
spraying the mixture of binder and the particles of the first magnetic material onto the sheet.

6. The method of claim 3, further comprising:
roll coating the mixture of binder and the particles of magnetic material onto the sheet.

7. A system for making a foam part including a sheet of material bonded to a surface of the part, comprising:
a mold having a first magnetic material coupled to an inner face of the mold, and
a sheet having particles of a second magnetic material coupled to at least a portion of at least one surface of a sheet.

8. The system of claim 7, further comprising:
a screen printable binder coupling the particles of magnetic material to the sheet.

9. The system of claim 7, wherein:
the first magnetic material coupled to the inner face of the mold comprises at least one magnet.

10. The system of claim 7, wherein:
the particles of the second magnetic material coupled to the sheet comprise a magnetic substance.

11. The system of claim 7, wherein:
the particles of the second magnetic material coupled to the sheet comprise iron.

12. The system of claim 7, wherein:
the particles of the second magnetic material coupled to the sheet have a nominal size of from 40 micron to 200 micron.

13. A reinforcing sheet for a surface of a molded foam part, comprising:
a sheet of material selected to provide strength to a surface of a molded foam part, and
particles of a magnetic material coupled to at least a portion of at least one surface of the sheet.

14. The reinforcing sheet of claim 13, further comprising:
a binder coupling the particles of magnetic material to the sheet.

15. The reinforcing sheet of claim 14, wherein the binder comprises a urethane binder.

16. The reinforcing sheet of claim 15, wherein the particles comprise iron.

17. The reinforcing sheet of claim 16, wherein the binder comprises an anticorrosion material.

18. The reinforcing sheet of claim 14, wherein the binder and the particles of magnetic material comprise a screen printable paste printed on the surface of the sheet.

19. The reinforcing sheet of claim 13, wherein the particles have a nominal size of from about 40 micron to about 200 micron.

20. The reinforcing sheet of claim 13, wherein the particles comprise iron.

21. The reinforcing sheet of claim 13, wherein the sheet comprises fibers selected from one or more of natural and synthetic fibers.

22. The reinforcing sheet of claim 13, wherein the sheet comprises fibers selected from one or more of cotton, rayon, cellulose, polyester, nylon, polypropylene, polyamide, and polyimide.
